(19) United States
(12) Patent Application Publication
(10) Pub. No.: US 2011/0161958 A1
(43) Pub. Date: Jun. 30, 2011

(54) Method and system for managing business calculations using multi-dimensional data

(75) Inventors: Hanping Xu, Edgewater, NJ (US); Michael Machlis, Cresskill, NJ (US); Donald Conte, Hillsdale, NJ (US)

(73) Assignee: JP Morgan Chase Bank

(21) Appl. No.: 11/028,384

(22) Filed: Jan. 3, 2005

(51) Int. Cl. G06F 9/46

(52) U.S. Cl. 718/100

(57) ABSTRACT

A method and system for managing and executing business formulas using a single platform includes a storage function for storing a plurality of business formulas in a single repository, where each business formula is defined using multi-dimensional data. The multi-dimensional data is accessible by employee-users of the business through a server communicatively connected to the repository. The employee-user may alter the multi-dimensional data of a business formula to incorporate modifications, as well as to create new business formulas. The server functions to execute business formulas contained within the repository. By allowing employee-users to modify existing business formulas and to input new business formulas directly into the system without requiring a programmer to write new software code, the efficiency of executing business formulas and implementing modifications is increased.

### BACKGROUND OF THE INVENTION

1. Field of the Invention

This invention relates to a method and system for managing and executing business calculations of an entire organization, using multi-dimensional data on a single platform.

2. Related Art

In the financial industry, an organization typically has its employees executing hundreds of thousands of business calculations on a given day to process all of the data moving throughout the organization. Most, if not all, of these calculations are executed by employees using multiple software applications, such as, for example, customized business applications. Although use of such business applications allow the data to be processed nearly contemporaneously with market fluctuations and customer transactions, often, throughout the day, these business calculations, referred to herein as business formulas, may change. Such changes require modifications to be made to the business applications which execute the business formulas, followed by distribution of these modified business applications to the employees who use the formulas. Additionally, new business formulas also may be created, and must be incorporated in the business applications used by the employees. Both modifications and new business formulas must be incorporated as quickly as possible to keep the data processing of the organization running smoothly and up to optimum speed.

Conventionally, modifications and new business formulas are implemented only by writing new software code for whatever business application is being used, otherwise known as hard-coding, or programming. Generally, this requires the assistance of a software programmer to perform the programming for each modification or new business formula. If a single business formula is executed by multiple employees using different business applications within the organization, new code must be written and implemented for each business application, and then distributed to each user of each application. Given the voluminous amount of data processed, it is not uncommon to have multiple modifications to a single business formula in one day, each of which requires programming for the respective business applications, and distribution to the respective users. Compound this situation with the enormous amount of business calculations being performed in a single day among multiple employees of the organization, and the time, money, and energy spent programming and distributing the modified and new business formulas to an entire organization grows exponentially, becoming inefficient in both time and cost.

Accordingly, a need exists for a system which provides easy access to multiple users where a user may quickly and easily implement new business formulas and modifications to business formulas, as well as interact with multiple business applications, in order to consolidate business operations and improve the overall efficiency of the organization.

### SUMMARY OF INVENTION

The present invention relates to a system and method for managing and executing business calculations using multi-dimensional data, referred to herein as “meta-data.” According to the invention, the system includes a server that interacts with multiple users and communicates with external sources, and a database, referred to herein as a system repository, which is communicatively connected to the server and contains configurable meta-data defining business formulas utilized within an organization. The system processes multiple business formulas utilized by users within the organization, and allows a user to enter modifications to business formulas as well as new or custom business formulas at the user's workstation without requiring separate programming for such modifications and new business formulas. Advantageously, all modifications and new business formulas are retained in the system repository and are available for use by any user within the organization. Additionally, the system may provide a result of a processed business formula in multiple formats and to multiple destinations. Further, multiple users may access and use the system simultaneously and independently of each other.

According to an aspect of the present invention, the system repository contains one or more tasks and one or more sets of instructions for processing a task. Each task is a collection of meta-data including a business formula, instructions for processing the task which includes executing the business formula, a list of inputs required from the user, referred to herein as “parameters,” and instructions for publishing or outputting the result of the processed task.

The system repository also contains a plurality of formula nodes, each of which is defined by its own meta-data. A business formula defined in a task may be a combination of one or more formula nodes and one or more mathematical operations and/or custom functions. Each formula node of the business formula is a link to its underlying meta-data. The meta-data of each formula node corresponds to an array of data items. Each data item has its own data value and is defined by one or more attributes. Each attribute is an array of data values. No actual data values are stored in the meta-data of a formula node except for one or more default attribute data values. Actual data values corresponding to both the data items and the attributes of a formula node may be retrieved by the system from sources external to the system. In the situation where attribute data values cannot be retrieved, the stored default attribute data values may be utilized.

The meta-data of a task may be altered by a user of the system in order to incorporate modifications to a business formula. Alternatively, a user may input information defining a new business formula, and the system incorporates the information and configures new meta-data to create a new task for the new business formula. By allowing a user to input modifications and new business formulas directly into the system, the need for programming of each modification and new formula is supplanted.

According to an embodiment of the present invention, a method is provided for modifying and executing a business formula. The method includes the steps of (i) accessing a system through a system interface, such as an intranet Web page or a business application, and (ii) selecting a pre-defined task defining a desired business formula to be executed. The system (iii) outputs the selected task and its underlying meta-data in order to receive any modifications to be made to the selected task's meta-data by the user via the system interface. The system (iv) accepts, through the system interface, any parameter(s) necessary to process the selected task, and (v) accepts a set of post-processing instructions for publishing a result of the processed task in one or more formats and to one or more destinations. Examples of destinations include a business application, a disk file, and an external information database.

The system processes the selected task by (vi) using the inputted parameter(s) to retrieve, from one or more sources external to the system, data values corresponding to formula nodes of the business formula of the selected task, (vii) assigning the retrieved data values to their corresponding formula nodes, and (viii) executing the business formula using a set of instructions defined in the meta-data of the selected task and the formula nodes to produce the result of the processed task. The system (ix) formats the result according to the post-processing instructions, and (x) publishes the result to one or more destinations. In this way, by communicating with multiple destinations, a result of a processed task may be utilized by different business applications and by multiple users. Additionally, the system (xi) retains in a system repository a modified task corresponding to the processed task, thus allowing the modified task to be accessed immediately by any user of the system.

The present invention removes the need for new software code to be written each time a business formula is modified, because the system of the present invention allows a user to make modifications to a business formula directly from the user's workstation. The system's ability to format and publish the result of an executed business formula to multiple destinations supplants writing new software code for a modified business formula for each business application which may utilize the result. By retaining or storing the modifications made to the business formula in a manner that allows multiple users to have direct access, multiple users may utilize the modified business formula without having to wait for a programmer to code and distribute the modified business formula to each destination.

According to another aspect of this embodiment, a method for creating a custom business formula is provided. The method allows a user to “program” or input into a system meta-data necessary to process a custom task, which defines the custom business formula, via a system interface. The user may input any combination of formula nodes, mathematical operations, and custom functions into the system as long as the chosen formula nodes, mathematical operations and custom functions currently exist in a system repository. As with a pre-defined task, the user may input any parameter(s) applicable to processing the custom task, instructions for processing the custom task, and post-processing instructions and destinations to configure and publish a processing result, respectively.

The user essentially “programs” the custom task and associated custom business formula into the system by inputting this information into the system, which then configures new meta-data to formulate a custom task to execute the custom business formula in accordance with the inputted information. The system processes the custom task using the same steps as those taken to process a pre-defined task. Since the system repository retains or stores the meta-data for all business formulas used throughout an organization, the custom task becomes readily available to others in the organization once stored by the system. This obviates the need for software code to be written defining a custom business formula for each business application, which may execute the custom business formula. This also removes the need for distributing the custom business formula to each user within the organization. By providing a common platform for all users within an organization to obtain new business formulas and to modify existing business formulas, the overall efficiency of the organization may increase significantly while reducing the manpower and costs associated with implementing new and modified business formulas.

### BRIEF DESCRIPTION OF THE DRAWINGS

The present invention will be more readily understood from the detailed description of an exemplary embodiment presented below considered in conjunction with the attached drawings, of which:

FIG. 1 illustrates a system according to an embodiment of the present invention;

FIGS. 2A and 2B illustrate a structure of a task and a structure of a formula node, respectively, according to an embodiment of the present invention;

FIGS. 3A and 3B are flow charts describing a processing flow of a method for executing a business formula according to an embodiment of the present invention, considered from an external user side and an internal system side, respectively; and

FIG. 4 presents an example of executing a business formula according to an embodiment of the present invention.

### DETAILED DESCRIPTION OF AN EXEMPLARY EMBODIMENT

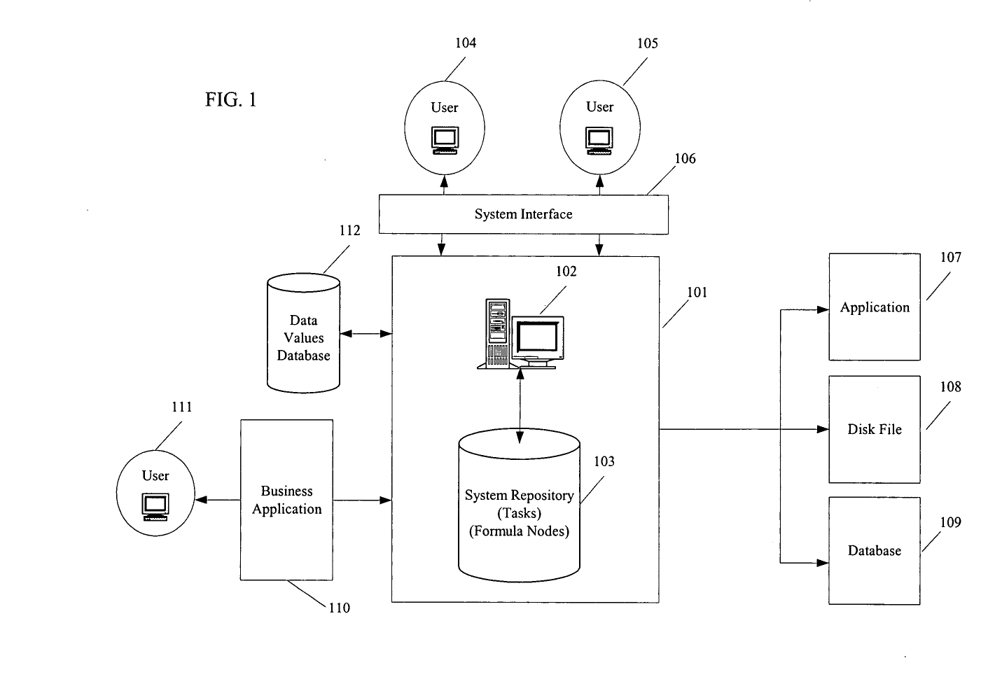

FIG. 1 illustrates a system arrangement for managing and processing a business formula according to an embodiment of the present invention. A system 101 includes a server 102, which executes business formulas used within an organization, and a system repository 103, which stores meta-data defining the business formulas used within the organization. Preferably, the system repository 103 is a computer-readable memory communicatively connected to the server 102.

The server 102 may be any type of computer adapted to distribute data and process data requests. The term “computer” refers to any of a single desktop computer, a laptop computer, a mainframe, or any device adapted to process data. The computer-readable memory referred to above may be internal or external to the server 102. The term, “computer-readable memory” refers to any data storage device readable by a computer, whether volatile or non-volatile or implemented electronically or otherwise, known in the art, including floppy disks, hard disks, CD-ROMs, DVDs, flash memories, non-volatile ROMs, and RAMs. The phrase “communicatively connected” refers to any manner of communication between or within devices known in the art, wired or wireless.

Multiple users 104, 105 may access the system 101 simultaneously from their respective workstations. Access occurs through a system interface 106 such as, for example, an intranet Web page. Alternatively, a user 111 may access the system 101 through a customized business application 110. The server 102 may publish a result of a processed business formula in multiple formats and to multiple destinations. Such destinations include, but are not limited to, a business application 107, such as a custom spreadsheet application, a disk file 108, such as a portable-document file (“PDF”), and an information database 109, which is external to the system 101.

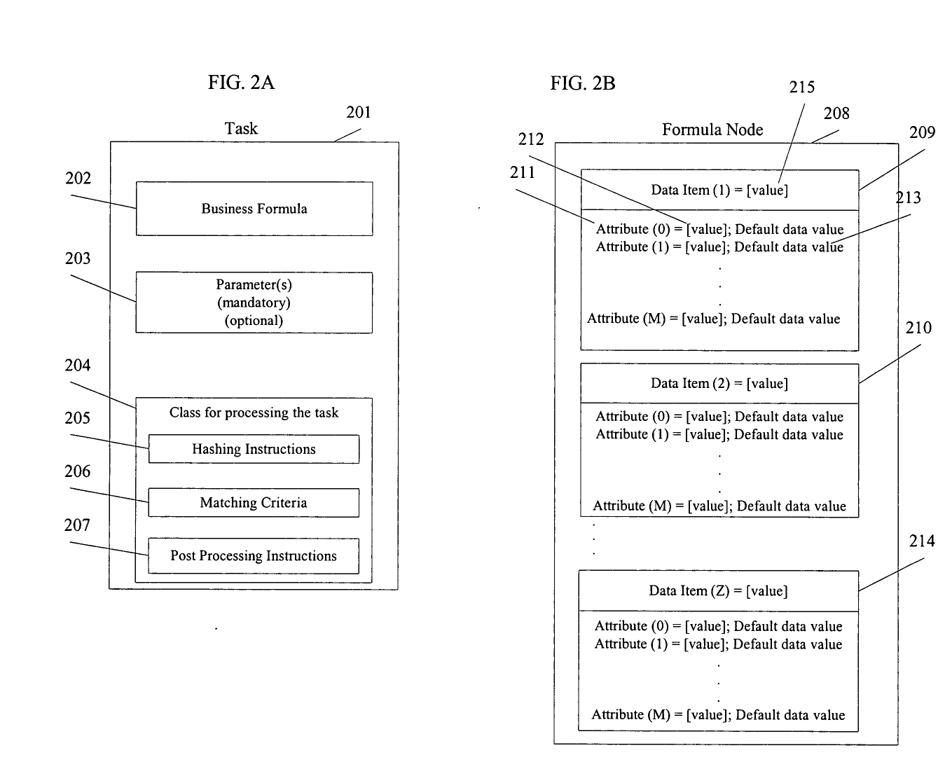

The meta-data stored in the system repository 103 may be split into two groups: task meta-data and formula node meta-data. FIGS. 2A and 2B illustrate a structure of a task and a structure of a formula node, respectively, each defined by its respective meta-data. Each business formula utilized by the organization may be executed by a corresponding task, and the system repository 103 may contain one or more tasks. The server 102 processes any task stored in the system repository 103 according to the task's meta-data.

For example, in FIG. 2A, the meta-data of the task 201 includes: a business formula 202, which includes a combination of formula nodes, mathematical operations, and custom functions; one or more parameters 203 inputted by a user 104, 105, which may include mandatory and/or optional parameters; a set of instructions for processing the task 201, referred to herein as a “class” 204; instructions 205 for normalizing or “hashing” data values retrieved from an external source which correspond to the combination of formula nodes; instructions 206 for matching data items between the formula nodes of the business formula; and post-processing instructions 207 for handling a processing result of the task 201. Although FIG. 2A shows the instructions 205, 206, 207 to be within the class 204, optionally, the instructions 205, 206, 207 may be separate from the class 204. Note that FIG. 2A presents an illustrative example of a task and its meta-data. Tasks with other meta-data are within the realm of the present invention.

A business formula defined within a task may be any business formula used by an employee of the organization. For example, a business formula may consist of the following:

X=A+B−C. (1)

To define this business formula in a task, the server 102 may configure the meta-data of the task 201 to have the following corresponding business formula 202:

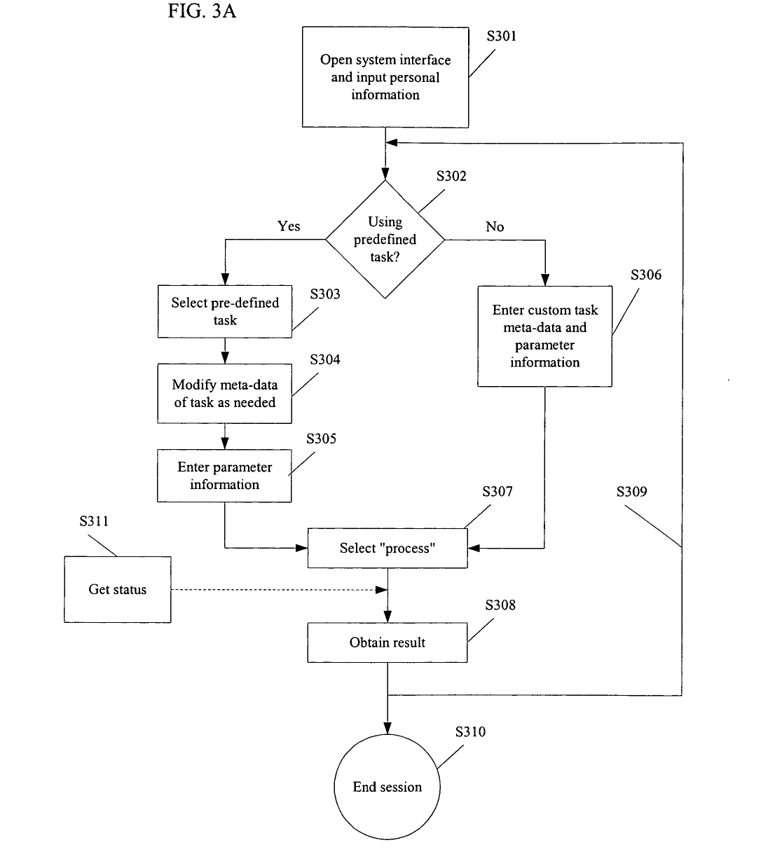

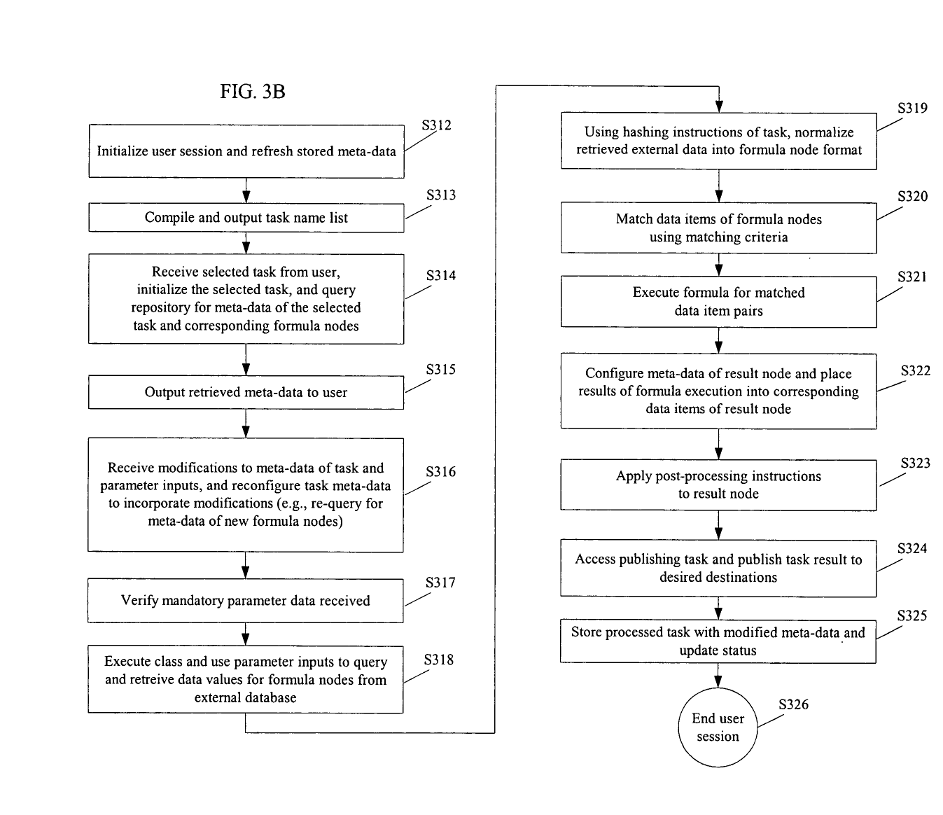

Result Node=Driving Node<op>Second Node<op>Third Node,

where “X” corresponds to a Result Node, “A” corresponds to a Driving Node, “B” corresponds to a Second Node, and “C” corresponds to a Third Node of the business formula 202. The term “Driving Node” refers to a component of a business formula from which other non-result formula nodes, such as the Second Node and Third Node of the business formula, are compared, or “matched” as part of processing the task 201. Such matching is described in more detail below in connection with FIGS. 3A and 3B. The term “<op>” represents any mathematical operation occurring between formula nodes, and in equation (1), “+” and “−” are the mathematical operations of the business formula 202.

Additionally, the business formula 202 may contain custom functions or custom operations, which have been previously defined and added to the system repository 103. New custom functions also may be added to the system repository 103 at any time, and further expand the utility of the system 101 across the organization.

One or more parameters 203 applicable to the business formula 202 may make up part of the meta-data of the task 201. A parameter 203 may be associated with data inputted by the user 104, 105 and, typically, is designated within the meta-data as either mandatory or optional. A task with a parameter designated as mandatory may not be processed by the server 102 until the user 104, 105 inputs data corresponding to the mandatory parameter, whereas a task with an optional parameter may be processed regardless of whether any data for the optional parameter is inputted. Data inputted by the user 104, 105 related to a parameter is used by the server 102 to query for and retrieve actual data values from one or more external sources within the organization, such as a data values database 112 as shown in FIG. 1. Such data values correspond to the formula nodes of the business formula 202. This process is described in greater detail below in connection with FIGS. 3A and 3B.

The task 201 shown in FIG. 2A includes meta-data corresponding to instructions for processing the task, or a class 204. All classes for the organization are stored within the system repository 103. Once processing for the task 201 begins, the server 102 uses the class 204 to execute a corresponding software routine stored in the system repository 103. The software routine associated with the class 204 may include instructions for retrieving external data values corresponding to the formula nodes of the business formula 202, for normalizing the retrieved data values, for matching data items across formula nodes, and for executing the business formula 202. The class 204 also may include post-processing instructions 207 applicable to the Result Node of the business formula 202.

When the server 102 retrieves data values from one or more external sources, such as the data values database 112, the data values must be re-aggregated or “normalized” to the internal format of the formula node as defined by the hashing instructions 205 included in the meta-data of the task 201. This internal format corresponds to the structure of the formula node, such as, for example, the formula node shown at 208. The meta-data of the task 201 also includes matching criteria 206, which is part of processing the task 201. Applying both the hashing instructions 205 and the matching criteria 206 is described in greater detail below in connection with FIGS. 3A and 3B.

The post-processing instructions 207 of the task 201 may be used to manipulate a structure of the Result Node into a specific format for a business application or other business purpose. As mentioned above, the server 102 may publish a result of a processed task in multiple formats and to multiple destinations. The server 102 applies the post-processing instructions 207 to format the result into formats desired by the user 104, 105. Post-processing is described in greater detail below in connection with FIGS. 3A and 3B.

Separate from the task meta-data stored in the system repository 103 is a group of meta-data defining formula nodes, where a formula node is a component of a business formula used in the organization. According to an embodiment of the present invention, the formula nodes identified in a business formula of a task are actually links to meta-data defining each identified formula node. The meta-data defining each formula node may have a structure similar to the formula node 208 of FIG. 2B, which includes an array of components, referred to herein as data items 209, 210, 214. The meta-data of a data item 209, 210, 214 includes one or more attributes 211, where each attribute is an array of one or more data values 212. The attributes 211 corresponding to each data item 209, 210, 214 of the formula node 208 are the same. However, data items 209, 210, 214 between formula nodes 208 may have different attributes 211, because different information may be reported in each formula node 208 of a business formula 202. Additionally, each attribute 211 may have an associated default attribute data value 213. The functions served by a data item 209, 210, 214, its corresponding attributes 211, and any associated default attribute data values 213 are described in greater detail below in connection with FIGS. 3A and 3B.

The meta-data of the formula node 208 is similar to an empty template with no actual data values stored therein, with the exception of the default attribute data values 213 associated with the attributes 211 of a data item 209, 210, 214. Actual data values corresponding to each data item 209, 210, 214 and the respective attributes 211 may be retrieved by the server 102 from one or more external sources, during the processing of the task 201. Each data value retrieved is assigned by the server 102 to a corresponding data item 209, 210, 214 as shown at 215, or to a corresponding attribute 211, as shown at 212. Advantageously, each attribute 211 may be assigned its associated default attribute data value 213 if a corresponding data value 212 may not be retrieved. The processes of retrieving data values and assigning default attribute data values are described in greater detail below in connection with FIGS. 3A and 3B.

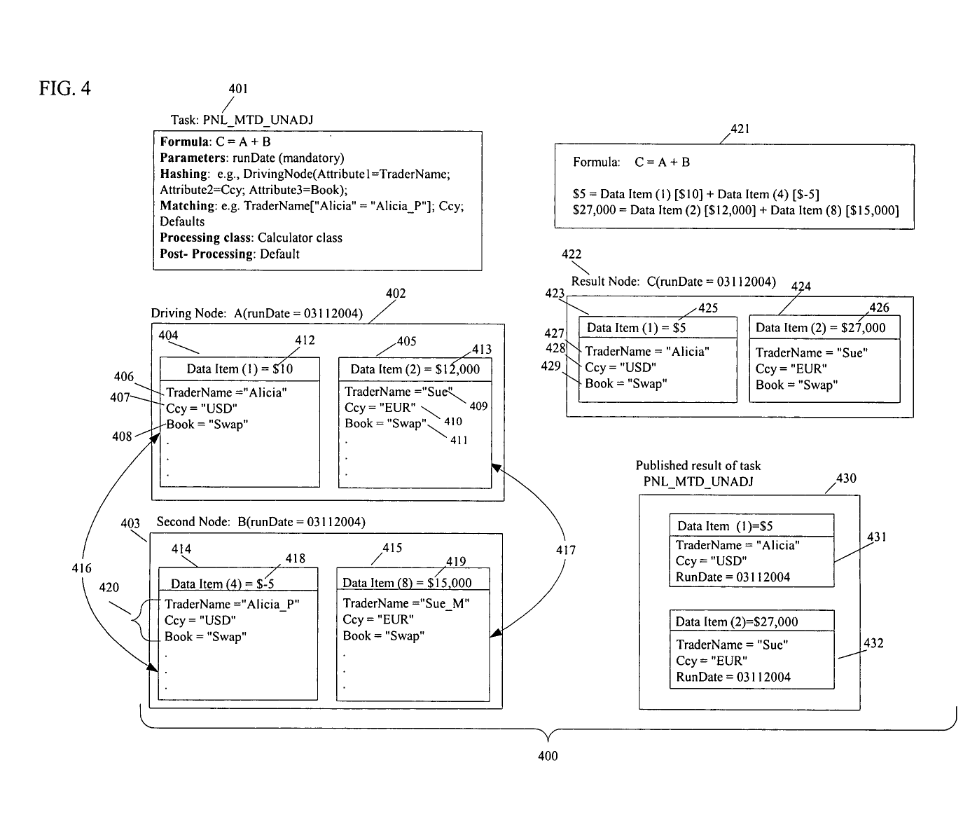

FIGS. 3A and 3B are flow charts which illustrate a method of modifying and executing a business formula according to an embodiment of the present invention. The steps shown in FIGS. 3A and 3B need not be performed in the sequence illustrated, and some steps may be performed essentially simultaneously. FIG. 3A illustrates the steps taken by a user 104, 105, while FIG. 3B illustrates the steps performed by the system 101 in response to the steps taken by the user 104, 105. FIG. 4 presents an example illustrating a processing of a task according to an embodiment of the invention. FIG. 4 is discussed in combination with FIGS. 3A and 3B.

To access the system 101, a user 104, 105 accesses a system interface 106 such as, for example, an intranet Web page, and initiates a user session by inputting personal information such as, a user identification number and a password, as shown at S301 in FIG. 3A. The server 102 receives and verifies the inputted personal information, and initializes a user session at S312 in FIG. 3B. Each user session is kept separate and distinct from any other user session running concurrently. By maintaining independence between user sessions, multiple users may use the system 101 simultaneously without disrupting each other's work.

Upon initializing a user session at S312, the server 102 refreshes all meta-data stored in the system repository 103, in order to provide the most current task and formula node meta-data to user 104, 105. The system repository 103 may be a static repository, for example, which stores only a single instance of all the meta-data. At the end of each user session, the server 102 stores the meta-data of a processed task, which may include modifications inputted by the user 104, 105 and essentially overwrites the previous instance of the task's meta-data stored in the system repository 103. Additionally, new formula nodes and new processing classes may be added to the system 101 by a system administrator. By refreshing the stored meta-data when a user session is initialized, at S312, the user 104, 105 with the most current instance of all the meta-data available.

After refreshing the meta-data, the server 102 queries the system repository 103 for current task names stored in the system repository 103, compiles a list of the current task names and displays the list to the user 104, 105 at S313, via the system interface 106. If the user 104, 105 wishes to process a pre-defined task at S302, the user 104, 105 selects a name corresponding to the pre-defined task from the list at S303. Alternatively, if the user 104, 105 wishes to create a new or custom task to execute a custom business formula, the user 104, 105 may do so by inputting the necessary information, at S306. Creating a custom task is described in greater detail below.

Once the server 102 receives the selected task 201, at S314 the server 102 initializes the selected task by generating a task identification number and setting an initial status associated with the selected task 201. The server 102 may update the status at any time while the user session is open, and may provide the current status to the user 104, 105 once processing begins, at S311. Initializing each selected task provides for asynchronous processing of tasks within the server 102, which allows other user sessions to run simultaneously without affecting each other. This feature increases the usability of the system 101 throughout the organization. Additionally, the server 102 queries the system repository 103 for meta-data defining the selected task 201 and the formula node(s) 208 corresponding to the business formula of the selected task 201 at S314.

Upon retrieving the meta-data for the selected task 201 and the meta-data of the corresponding formula node(s) 208, the server 102 outputs both the meta-data of the selected task 201 and the meta-data of the formula node(s) 208 to the user 104, 105, at S315, to allow user 104, 105 to modify or alter the meta-data of the selected task 201 in light of the meta-data of the corresponding formula node(s) 208. Although the user 104, 105 may not alter the meta-data defining a formula node 208, the user 104, 105 may alter any of the meta-data of the selected task 201, at S304, thereby allowing the user 104, 105 to modify a business formula in real time without requiring additional programming or software knowledge. Additionally, at S305, the user 104, 105 may enter parameter data corresponding to the mandatory and optional parameter(s) 203 for the selected task 201.

An example illustrating a processing of a task 400 is shown in FIG. 4. According to FIG. 4, a user 104, 105 desires to execute a business formula for an unadjusted month-to-date daily Profit & Loss (“P&L”) amount for multiple traders within an organization. A task for executing the business formula exists in the system 101 as “PNL_MTD_UNADJ” 401. Upon initiating a user session, at S301, and designating that a pre-defined task is to be used, at S302, the server 102 initializes a user session and refreshes the stored meta-data, at S312, compiles a list of available task names, at S313, and outputs the list of the task names to user 104, 105. The user 104, 105 then may select the task “PNL_MTD_UNADJ” 401 from the outputted list, at S303.

The server 102 receives the selected task “PNL_MTD_UNADJ” 401, initializes the selected task “PNL_MTD_UNADJ” 401, and queries the system repository 103 for meta-data defining the selected task, “PNL_MTD_UNADJ” 401, at S314. The meta-data of the selected task “PNL_MTD_UNADJ” 401 may include multiple components as described above with respect to FIG. 2, including the following business formula:

C=A+B

where “A” is the current day's daily P&L, “B” is the prior business day's month-to-date P&L, and “C” is the result sought by the user 104, 105. In accordance with an embodiment of the present invention, “A” is the Driving Node, “B” is the Second Node, and “C” is the Result Node of the business formula. As discussed above, the term “Driving Node” refers to a component of a business formula from which other non-result nodes, such as the “Second Node” of the business formula, are compared, or “matched,” as part of the server 102 processing a task.

The server 102 uses the formula nodes identified in the business formula of the selected task “PNL_MTD_UNADJ” 401, i.e., “A” 402 and “B” 403, to retrieve the meta-data defining these formula nodes from the system repository 103, at S314. Accordingly, the server 102 displays the meta-data for the formula nodes, “A” 402 and “B” 403, to the user 104, 105 via the system interface 106, at S315. The other components of the meta-data for the selected task “PNL_MTD_UNADJ” 401 include a mandatory parameter “runDate” to be entered by the user 104, 105, the “Calculator” class for processing the selected task “PNL_MTD_UNADJ” 401, hashing instructions, matching criteria, and post-processing instructions applicable to the Result Node “C.”

Once the server 102 displays the meta-data for the selected task “PNL_MTD_UNADJ” 401 and the meta-data for the formula nodes “A” 402 and “B” 403, the user 104, 105 may modify the displayed meta-data of the selected task “PNL_MTD_UNADJ” 401 as needed, at S304. Examples of modifications include, but are not limited to, altering the displayed business formula “C=A+B,” for example, by changing the “+” to a “−,” replacing the Driving Node “A” 402 with a different pre-defined formula node, and/or adding one or more formula nodes, mathematical operations, or custom functions to the business formula.

The user 104, 105 may modify the parameter(s) 203 of the selected task 201, choose a different class 204 for processing the selected task 201, alter the hashing instructions 205, the matching criteria 206, and/or the post-processing instructions 207 of the meta-data of the selected task 201, at S304. The user 104, 105 may modify the hashing instructions 205 and the matching criteria 206 based on attributes currently displayed in the meta-data of the formula node(s) 208 of the selected task 201. Modifying the post-processing instructions 207 informs the server 102 of the formats that the processing result of the selected task 201 should be published in, and the destinations that the processing result should be published to. As mentioned above, the system 101 is able to publish the processing result to multiple destinations, such as a business application 107, a disk file 108, or an external information database 109. By reconfiguring the meta-data of the selected task 201 directly through the user interface 106, modifications to a business formula may be incorporated into the system 101 without requiring software code to be written and released for each modification. Additionally, because the system 101 retains all modifications made to the selected task 201, any user within the organization may utilize the modified task, further removing the need for software updates to be released each time a business formula changes.

Accordingly, at S316, the server 102 receives the modifications inputted by the user 104, 105 at S304, and reconfigures the meta-data of the selected task 201 according to those modifications. Reconfiguration may include the server 102 re-querying the system repository 103 for meta-data defining other formula nodes, which may be part of a modified business formula, and displaying the meta-data defining the other formula nodes to the user 104, 105 at which point, the user 104, 105 may re-modify the meta-data of the selected task 201 based on the other formula nodes of the modified business formula.

Once the server 102 completes reconfiguring the meta-data of the selected task 201 to incorporate any modifications made by the user 104, 105, the server 102 verifies that data for all parameters designated as mandatory has been received, at S317. If data for all mandatory parameters have not been received, the server 102 may generate and display a fault notice to the user 104, and may halt further processing.

Looking to the example provided in FIG. 4, at S316, the server 102 receives any modifications made by the user 104, 105 to the meta-data of the selected task “PNL_MTD_UNADJ” 401. As shown in FIG. 4, the parameter “runDate” is designated as a mandatory parameter, i.e., data corresponding to the parameter “runDate” must be entered by the user 104, 105 before the server 102 can begin processing the selected task “PNL_MTD_UNADJ” 401. Accordingly, at S305, the user 104, 105 enters a specific date for the parameter “runDate.” For example, the user 104, 105 may enter “03112004,” which correlates to Mar. 11, 2004. Upon receiving the parameter data, the system 102 verifies that data for all mandatory parameters has been received, at S317. Since “runDate” is the lone parameter defined in the meta-data of the task 401, verification is successful.

Once the server 102 has incorporated the modifications into the selected task's 201 meta-data, at S316, and has verified the receipt of all mandatory parameter data, at S317, the server 102 is ready to process the selected task 201. At S307, the user 104 commands the server 102 to process the selected task 201. During task processing, the server 102 continuously updates the task status, which the user 104, 105 may obtain by simply requesting it, as shown at S311 in FIG. 3A.

To process the selected task 201, at S318, the server 102 executes the class 204 for processing the selected task 201, which is named in the selected task's 201 meta-data. As mentioned above, the class 204 designated in the selected task's 201 meta-data is a link to a corresponding task-processing software routine, which may be stored in the system repository 103. As mentioned above, the meta-data stored for a formula node, such as the formula node 208 as shown in FIG. 2B, is similar to an empty template with the exception of default attribute data values 213. An organization may have voluminous amounts of data that correlate to the formula node(s) 208 of the selected task 201. To retrieve only the data required by the user 104, 105, at S318, the server 102 uses the parameter(s) 203 inputted by the user 104, 105 to query one or more external sources for corresponding data values as part of processing the selected task 201. Thus, in FIG. 4, the server 102 uses the value “03112004” inputted by the user 104, 105 for the parameter “runDate” to search for data values specific to this inputted date and which correspond to the formula nodes “A” 402 and “B” 403. This search produces data values corresponding to two data items in each formula node, Data Items (1) 404 and (2) 405 in the Driving Node “A” 402, and Data Items (4) 414 and (8) 415 in the Second Node “B” 403.

As mentioned above, the external data retrieved by the server 102 at S318, must be re-aggregated or normalized into an internal format that corresponds to the data item and attribute structure of the formula node 208. This internal format is defined, for example, by the hashing instructions 205 in the meta-data of the selected task 201.

At S319, the server 102 applies the hashing instructions 205 of the selected task 201 to normalize the retrieved data values to an internal format that corresponds to the defined structure of the formula node(s) 208 of the business formula 202. As discussed above in connection with FIG. 2B, a formula node 208 is an array of data items 209, 210, 214, where each data item 209, 210, 214 is defined by a set of attributes 211 and corresponding attribute data values 212. Additionally, each data item 209, 210, 214 has an associated data value 215. All data values retrieved during S318 must be normalized into the data item and attribute structure as shown in the formula node 208 in order to guarantee that each data item 209, 210, 214 is represented in a uniform internal format and that the desired attributes 211 will be present according to the business needs of the user 104, 105.

Upon applying the hashing instructions 205 of the selected task 201, the server 102 re-aggregates the retrieved data values to correspond with the internal format defined in the hashing instructions, as shown in the formula node 208. Thus, data item 209 now has a corresponding data value 215, and underlying attributes 211 with data values 212. The attributes 211 which correspond to the hashing instructions 205 are designated as hashing attributes. Any attributes 211 that are not designated as hashing attributes are excluded from the processing of the selected task 201.

In FIG. 4, the hashing instructions of the task “PNL_MTD_UNADJ” 401 define a set of attributes for the data items of the Driving Node “A” 402 and a set of attributes for the data items of the Second Node “B” 403. For the Data Items (1) 404 and (2) 405 of the Driving Node “A” 402, some of the attributes defined include a TraderName 406, 409, a Ccy 407, 410, and a Book 408, 411, where the attribute TraderName 406, 409 correlates to the name of an employee performing trades, the attribute Ccy 407, 410 correlates to a type of currency applied to the trades, and the attribute Book 408, 411 correlates to a type of trade being performed. As shown in FIG. 4, the Data Item (4) 414 and the Data Item (8) 415 of Second Node “B” 403 each have attributes similar to the Data Items (1) 404 and (2) 405 of the Driving Node “A” 402.

Although the attributes of the data items shown in FIG. 4 are the same, one of ordinary skill would recognize that the attributes may be different between formula nodes, because different business information may be sought for each formula node. For example, the attributes of Data Items (1) 404 and (2) 405 of the Driving Node “A” 402 may include such attributes as “BusinessUnit” and “Branch” whereas the Data Items (4) 414 and (8) 415 of the Second Node “B” 403 may include other attributes.

The hashing instructions of the task “PNL_MTD_UNADJ” 401 inform the server 102 that the attributes TraderName 406, 409, Ccy 407, 410, and Book 408, 411 are hashing attributes for all data items in the Driving Node “A” 402. That is, when the server 102 normalizes the retrieved data values from an external format(s) into the internal format designated by the hashing instructions defined in the meta-data of the task “PNL_MTD_UNADJ” 401, these attributes will be present for each of the Data Items (1) 404 and (2) 405 in the Driving Node “A” 402 and the Data Items (4) 414 and (8) 415 in the Second Node “B” 403. As discussed above, the hashing instructions defined in a task's meta-data may be reconfigured by the user 104, 105 at S304 in FIG. 3A.

In FIG. 4, the server 102 normalizes the retrieved data values at S319 to produce the following: the Data Item (1) 404 has a data value of “10,” as shown at 412, the Data Item (2) 405 has a data value of “12,000,” as shown at 413, the Data Item (4) 414 has a data value of “−5,” as shown at 418, and the Data Item (8) 415 has a data value of “15,000,” as shown at 419. The hashing attributes for the Data Item (1) 404 have the following values: the attribute TraderName 406 has the value “Alicia,” the attribute Ccy 407 has the value “USD,” and the attribute Book 408 has the value “Swap.” Similarly, for the Data Item (2) 405, the attribute TraderName 409 has the value “Sue,” the attribute Ccy 410 has the value “USD,” and the attribute Book 411 has the value “Swap.”

Once all retrieved data values have been normalized and re-aggregated into the internal formula node format at S319, task processing progresses to matching the data items 209, 210, 214 across formula nodes using the matching criteria 206 defined in the selected task's 201 meta-data, at S320. Of the hashing attributes for each data item 209, 210, 214, one or more hashing attributes may be designated as “matching” attributes, where a matching attribute corresponds to the matching criteria 206 in the meta-data of the selected task 201. In order to execute a business formula, each data item 209, 210, 214 of a Driving Node of the business formula must be matched to a data item 209, 210, 214 in each other non-result formula node 208 of the business formula. To perform the matching, the server 102 applies the matching criteria 206 of the selected task 201 to the matching attributes in a first data item 209, 210, 214 of the Driving Node and loops through each data item 209, 210, 214 in the other non-result formula node(s) of the business formula 202 of the selected task 201 until a match is determined for the first data item 209, 210, 214. The server 102 then repeats the matching process until all matches between the formula nodes 208 have been identified in accordance with the matching criteria 206.

An example of the matching criteria of the selected task “PNL_MTD_UNADJ” 401 may include the following:

TraderName[“Alicia”=“Alicia_{—}P”]; Ccy; Defaults.

The above matching criteria specifies that a match between the data items of the Driving Node “A” 402 and the Second Node “B” 403 may occur using the attributes TraderName 406, 409 and Ccy 407, 410, which are matching attributes. Because the matching criteria does not designate the attribute Book 408, 411 as a matching attribute, the server 102 does not consider the attribute Book 408, 411 in the matching process. The term “Defaults” specifies that a default attribute data value should be used for any matching attribute in a non-result formula node for which no data value is assigned.

According to the above matching criteria, if a data item in the Driving Node “A” 402 has a data value of “Alicia” for the attribute TraderName 406, 409, a matching data item in the Second Node “B” 403 should have a data value of “Alicia_P” for the same attribute, i.e., TraderName, as shown at 420. For the attribute Ccy 407, 410, a data item in the Second Node “B” 403 having the same data value as a current data value in a data item of the Driving Node “A” 402, i.e., “USD”, is a match. At S320, the server 102 applies this matching criteria and loops through the data items of the Driving Node “A” 402 and the data items of the Second Node “B” 403 to find one or more matched sets of data items. In FIG. 4, the Data Item (4) 414 of the Second Node “B” 403 is a match to the Data Item (1) 404 of the Driving Node “A” 402. Similar matching criteria may exist for the Data Item (2) 405 of the Driving Node “A” 402, which matches the Data Item (8) 415 of the Second Node “B” 403.

If no data value had been retrieved for the attribute Ccy 407, 410 in one or more of the data items in FIG. 4, according to the matching criteria above, the server 102 assigns a default attribute data value as it is defined in the meta-data for each formula node. An empty matching attribute, that is, a matching attribute with no data value assigned to it, may be left out of the business formula execution, which may result in significant data being left out of the business formula execution, and, thus, out of the processed result. Assigning a default data value to an empty or unmatched matching attribute ensures that the attribute and its respective data will not be left out of the business formula's execution and the Result Node. By assigning a default attribute data value, the matching process is prevented from failing and, thereby, interrupting the processing of the selected task.

Once the server 102 completes the matching process, the data items of the formula nodes are now linked into one or more matched sets of data items. At S321, the server 102 executes the business formula using the matched sets of data items. In FIG. 4, the server 102 executes the business formula “C=A+B,” shown at 421, using the matched data items shown at 416 and 417. Executing the business formula produces the calculations shown at 421. Thus, “A” Data Item (1) [10]+“B” Data Item (4) [−5]=5, and “A” Data Item (2) [12,000]+“B” Data Item (8) [15,000]=27,000.

At S322, the server 102 assigns the results of executing the business formula using the matched data items to each data item in the Result Node of the business formula. Thus, in FIG. 4, the result of the matched set of data items at 416 is placed into Data Item (1) 423 of the Result Node “C” 422, as shown at 425. The result of the matched set of data items at 417 is placed into Data Item (2) 424 of the Result Node “C” 422, as shown at 426. Once the result data values have been assigned to data items in the Result Node, the server 102 configures the meta-data of the Result Node to imitate the data items of each matched set of data items. Specifically, the meta-data for each data item in the Result Node is configured to create a collective set of hashing attributes from the corresponding matched set of data items. The server 102 then assigns data values to the hashing attributes of each data item of the Result Node corresponding to the data values of the hashing attributes of the data item of the Driving Node that produced the particular result data item.

Thus, in FIG. 4, in the Result Node “C” 422, the server 102 configures the Data Item (1) 423, which has a result data value of “5,” as shown at 425, to have a collective set of hashing attributes from the Data Item (1) 404 of the Driving Node “A” 402 and the Data Item (4) 414 of the Second Node “B” 403, i.e., TraderName 427, Ccy 428, and Book 429. The data values assigned to the attributes TraderName 427, Ccy 428, and Book 429 in the Data Item (1) 423 correspond to the data values of the hashing attributes of the Data Item (1) 404 of the Driving Node “A” 402, that is, the data value “Alicia” is assigned to the attribute TraderName 427, the data value “USD” is assigned to the attribute Ccy 428, and the data value “Swap” is assigned to the attribute Book 429. Note that although the attribute Book 429 was not designated as a matching attribute, the server 102 configures the attributes of the data items in the Result Node “C” 422 from the hashing attributes, and not from the matching attributes.

Similarly, the set of attributes configured for the Data Item (2) 424 of the Result Node “C” 422, which has a result data value of 27,000, as shown at 426, is the collective set of hashing attributes of both the Data Item (2) 405 in the Driving Node “A” 402 and the Data Item (8) 415 in the Second Node “B” 403. Accordingly, the data values assigned to the attributes of the Data Item (2) 424 are the same as those of the hashing attributes of the Data Item (2) 405 in Driving Node “A” 402.

After the server 102 completes configuring the data items of the Result Node, at S322, the server 102 applies the post-processing instructions 207 defined in the meta-data of the selected task to format the Result Node, at S323. As discussed above, the server 102 is able to publish a Result Node in multiple formats according to the post-processing instructions 207 in the task's meta-data, which are configurable by the user 104, 105. One example of a post-processing instruction is to re-aggregate the attributes of the data items in the Result Node to report only certain information. Thus, the user 104, 105 may modify the post-processing instructions 207 to collapse or condense certain attributes and their respective data values. Optionally, the user 104, 105 may modify the post-processing instructions 207 such that additional information may be reported at the Result Node, which did not come from the hashing attributes of the corresponding data items, such as inputted parameter data. Another example of post-processing instructions 207 may call for collapsing the data items of the Result Node into a single data item, in order to report an average of the data items at the Result Node.

In FIG. 4, the meta-data of the task “PNL_MTD_UNADJ” 401 lists “Default” for the post-processing instructions, which informs the server 102 that the default post-processing instructions are to be applied if no modifications were made by the user 104, 105. At S323, server 102 applies the post-processing instructions to produce the results at the Result Node “C” as shown at 430. The attributes of the Data Items (1) 431 and (2) 432 of the Result Node “C” 430 have been re-aggregated to report only the attribute TraderName and the attribute Ccy, and their respective data values. Additionally, the parameter “runDate” has been incorporated into both Data Items (1) 431 and (2) 432 of the Result Node “C” 430, even though it is not an attribute of either of the Data Items (1) 404 and (2) 405 of the Driving Node “A” 402 or of the Data Items (4) 414 and (8) 415 of the Second Node “B” 403.

Because the Result Node may be published in multiple formats, the user 104, 105 may utilize a result of a processed task in multiple business applications. Once the server 102 has formatted the Result Node according to the post-processing instructions 207 of the selected task 201 at S323, the server 102, at S324, accesses a pre-defined publishing task stored in the system repository 103 to publish the results at the Result Node to the destinations previously inputted by the user 104, 105, as part of the modifications to the selected task's meta-data at S304. The user 104, 105 then may obtain the result of the processed task at one or more desired destinations, at S308. As mentioned above, the server 102 may publish a result of a processed task to one or more destinations based on the business needs of the user 104, 105. These destinations may include, but are not limited to, a business application 107, a disk file 108, and an external information database 109. Other destinations may include another server within the organization or another user's workstation. As an organization expands to incorporate new business applications into its network, the system of an embodiment of the present invention may expand to interact with any new additions, thus providing a flexible system which is easily adaptable to the organization's changing needs.

Once the server 102 publishes the result of the processed task to the designated destinations at S324, the server 102 stores the selected task 201 and any modifications which may have been made to the meta-data of the selected task 201 by the user 104, 105, at S325. The server 102 also updates the status of the selected task 201. Because the system repository 103 stores the most recent instance of the task's meta-data, any modifications to the meta-data will remain intact until another user alters the meta-data of the same task. The user 104, 105 then may either maintain the user session to execute additional business formulas, at S309, or end the user session, at S310. If the user 104, 105 ends the user session, the server 102 terminates the user session, at S326.

As mentioned above, a user 111 may access and utilize the system 101 through a business application 110, instead of the system interface 106, to modify and execute a business formula in accordance with the steps shown in FIG. 3A. One of ordinary skill would recognize that a business application may be created and/or adapted to communicate with a system according to an embodiment of the present invention.

Alternatively, the user 104, 105 may utilize the system 101 to execute a custom business formula, which is not defined by a task currently stored in the system repository 103. So long as the custom business formula is a combination of pre-defined formula nodes and pre-defined mathematical operations and/or custom functions currently existing in the system 101, the user 104, 105 may create a custom task via the system interface 106 instead of requiring a programmer to write software code to execute the custom business formula.

To create a new or custom task, upon establishing a user session at S301, the user 104, 105 may “code” the custom task into the system 101 by entering the necessary information, at S306, via the system interface 106. Similar to inputting modifications to the meta-data of a selected task, the user 104, 105 inputs a custom business formula using pre-defined formula nodes and pre-defined mathematical operations and/or custom functions, as well as a name for the custom task. Upon inputting the custom business formula and the name of the custom task, the server 102 initializes the custom task, similar to step S314, but queries the system repository 103 only for the meta-data defining the pre-defined formula nodes of the custom business formula. The server 102 then displays the meta-data for each formula node, similar to step S315 in FIG. 3B.

The user 104, 105 then inputs information to configure new meta-data for the custom task, at S306, such as one or more parameters, a name of a pre-defined class to process the custom task, hashing instructions and matching criteria based on attributes displayed in the meta-data of the formula nodes, and post-processing instructions applicable to a result of the custom task. The user 104, 105 also inputs one or more destinations for the server 102 to publish the result of the custom task. After inputting the necessary information, the user 104, 105 commands the server 102 to create the custom task, at S307.

Accordingly, the server 102 receives the inputted information and creates the custom task by configuring new meta-data using the inputted information, similar to step S316 in FIG. 3B. Once the server 102 creates the custom task, processing the custom task follows similar steps as those shown in FIG. 3B processing a modified pre-defined task. Again, as long as the custom business formula may be defined by a combination of pre-defined formula nodes and pre-defined mathematical operations and custom functions, the system 101 is able to create a custom task to execute the custom business formula to be utilized in the organization. Additionally, new formula nodes and task processing classes may be added to the system 101, for example, by a system administrator, in order to expand the utility of the system 101. Thus, the system 101 is adaptable to the changing business needs of the organization while advantageously bypassing the necessity of a programmer to write code for all custom business formulas, by allowing the user to “program” a custom business formula into the system 101.

Optionally, a user 111 may access and utilize the system 101 through a business application 110, instead of the system interface 106, to execute a custom business formula in accordance with the steps shown in FIG. 3A. One of ordinary skill would recognize that a business application may be created and/or adapted to communicate with a system according to an embodiment of the present invention.

While the present invention has been described with respect to what is presently considered to be a preferred embodiment, it is to be understood that the invention is not limited to the disclosed embodiment. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A method for managing and executing a business formula on a computer of a network of multiple computers, the method comprising the steps of:
storing multi-dimensional data in a computer-readable memory,
wherein the multi-dimensional data includes a plurality of tasks, a plurality of formula nodes, and a plurality of processing instructions,
wherein each task is comprised of a business formula defined by a set of formula nodes from the plurality of formula nodes, and a set of processing instructions from the plurality of processing instructions,
wherein each formula node is comprised of at least one data item, and
wherein a data item is associated with at least one attribute defining a content of that data item;
receiving a selection identifying a selected task for processing from the plurality of tasks;
receiving inputted data related to the selected task, wherein the inputted data is comprised of data for modifying the selected task;
receiving parameter data related to the selected task;
processing the selected task utilizing the inputted data and the parameter data in accordance with a set of processing instructions associated with the selected task; and
modifying the selected task using the inputted data while processing the selected task.

2. The method of claim 1, wherein the multi-dimensional data is meta-data.

3. (canceled)

4. The method of claim 1, wherein modifying the selected task includes modifying the business formula using the inputted data.

5. The method of claim 1, further comprising the steps of:
initializing a user session to process a task;
retrieving the plurality of tasks stored in the computer-readable memory; and
outputting the plurality of tasks through an interface.

6. The method of claim 5, wherein the initialization step includes refreshing the multi-dimensional data stored in the computer-readable memory.

7. The method of claim 1, further comprising the steps of:
retrieving a first set of multi-dimensional data from the computer-readable memory, wherein the first set of multi-dimensional data corresponds to the selected task;
retrieving a second set of multi-dimensional data from the computer-readable memory, wherein the second set of multi-dimensional data corresponds to a set of formula nodes associated with the selected task; and
outputting the first set of multi-dimensional data and the second set of multi-dimensional data through an interface.

8. The method of claim 7, further comprising the step of setting a status associated with the selected task.

9. The method of claim 8, further comprising the step of updating the status associated with the selected task during the processing step of the selected task.

10. The method of claim 8, further comprising the step of outputting the status associated with the selected task.

11. The method of claim 7, further comprising the steps of:
receiving modifications to the first set of multi-dimensional data associated with the selected task; and
reconfiguring the first set of multi-dimensional data according to the received modifications.

12. The method of claim 11, wherein the step of reconfiguring includes reconfiguring the set of formula nodes associated with the selected task by removing, adding, or removing and adding at least one formula node.

13. The method of claim 12, further comprising the step of retrieving a third set of multi-dimensional data from the computer-readable memory, wherein the third set of multi-dimensional data is utilized in the step of reconfiguring the set of formula nodes associated with the selected task.

14. The method of claim 11, wherein the step of reconfiguring includes altering the set of processing instructions associated with the selected task.

15. The method of claim 1, wherein the step of processing further comprises:
retrieving data values from at least one external source, wherein the data values are associated with the set of formula nodes associated with the selected task;
assigning a first set of the retrieved data values to each data item of each formula node of the set of formula nodes associated with the selected task;
assigning a second set of the retrieved data values to each attribute associated with each data item of each formula node of the set of formula nodes associated with the selected task;
matching data items between each formula node of the set of formula nodes associated with the selected task in accordance with the set of processing instructions associated with the selected task; and
producing at least one matched set of data items.

16. The method of claim 15, further comprising the step of normalizing the retrieved data values to a format defined by the set of processing instructions associated with the selected task.

17. The method of claim 15, further comprising the step of assigning a default data value to each attribute associated with each data item of each formula node of the set of formula nodes associated with the selected task when the attribute is not assigned a data value.

18. The method of claim 17, wherein the default data value is defined according to its corresponding attribute.

19. The method of claim 15, wherein the step of matching includes matching a data value assigned to each attribute associated with each data item of a first formula node in the set of formula nodes associated with the selected task, to a data value assigned to each attribute associated with each data item of other formula nodes in the set of formula nodes associated with the selected task, in accordance with the set of processing instructions associated with the selected task, wherein no formula node involved in the matching step is a result formula node.

20. The method of claim 15, further comprising the step of executing a business formula corresponding to the selected task using the at least one matched set of data items.

21. The method of claim 1, further comprising the step of publishing a result from processing the selected task.

22. The method of claim 21, further comprising the step of structuring the result in accordance with at least one formula node from the set of formula nodes associated with the selected task.

23. The method of claim 21, further comprising the step of storing a plurality of formats and a plurality of destination data in the computer-readable memory, wherein the step of publishing includes applying at least one format of the plurality of formats to the result to produce a formatted result, and sending the formatted result to at least one destination of the plurality of destinations.

24-41. (canceled)

42. A system for managing business formulas comprising:
a computer-readable memory storing multi-dimensional data,
wherein the multi-dimensional data includes a plurality of tasks, a plurality of formula nodes, and a plurality of processing instructions,
wherein each task is comprised of a business formula defined by a set of formula nodes from the plurality of formula nodes, and a set of processing instructions from the plurality of processing instructions,
wherein each formula node is comprised of at least one data item, and
wherein a data item is associated with at least one attribute defining a content of that data item; and
a central processor communicatively connected to the computer-readable memory, wherein the central processor includes one or more modules configured to:
receive a selection identifying a selected task for processing from the plurality of tasks;
receive inputted data related to the selected task, wherein the inputted data is comprised of data for modifying the selected task;
receive parameter data related to the selected task;
process the selected task utilizing the inputted data and the parameter data in accordance with a set of processing instructions associated with the selected task; and
modify the selected task using the inputted data while the selected task is being processed.

43. The system of claim 42, further comprising an interface for enabling communications between the central processor and one or more external computers.

44. The system of claim 42, further comprising a plurality of user computers communicatively connected to the central processor.

45. The system of claim 44, wherein more than one of the plurality of user computers are able to communicate with the central processor simultaneously.

46. The system of claim 44, wherein the plurality of user computers operate independently of each other.

47-51. (canceled)

52. A computer-readable memory medium storing computer code for implementing a method for managing and executing a business formula on a computer of a network of multiple computers, wherein the method comprises the steps of:
storing multi-dimensional data in a computer-readable memory,
wherein the multi-dimensional data includes a plurality of tasks, a plurality of formula nodes, and a plurality of processing instructions,
wherein each task is comprised of a business formula defined by a set of formula nodes from the plurality of formula nodes, and a set of processing instructions from the plurality of processing instructions,
wherein each formula node is comprised of at least one data item, and wherein a data item is associated with at least one attribute defining a content of that data item;
receiving a selection identifying a selected task for processing from the plurality of tasks;
receiving inputted data related to the selected task, wherein the inputted data is comprised of data for modifying the selected task;
receiving parameter data related to the selected task; and
processing the selected task utilizing the inputted data and the parameter data in accordance with a set of processing instructions associated with the selected task; and
modifying the selected task using the inputted data while processing the selected task.

53. (canceled)
